(19) United States
(12) Patent Application Publication
(10) Pub. No.: US 2012/0144175 A1
(43) Pub. Date: Jun. 7, 2012

(54) METHOD AND APPARATUS FOR AN ENHANCED SPEED UNIFIED SCHEDULER UTILIZING OPTYPES FOR COMPACT LOGIC

(75) Inventors: Ganesh Venkataramanan, Sunnyvale, CA (US); Emil Talpes, Sunnyvale, CA (US)

(73) Assignee: ADVANCED MICRO DEVICES, INC., Sunnyvale, CA (US)

(21) Appl. No.: 12/958,604

(22) Filed: Dec. 2, 2010

(51) Int. Cl. G06F 9/22

(52) U.S. Cl. 712/246; 712/E09.004

(57) ABSTRACT

An integrated circuit is disclosed wherein microinstructions are selectively queued for execution in an execution unit having multiple pipelines where each pipeline is configured to execute a selected subset of a set of supported microinstructions. The execution unit receives microinstruction data including an operation code OpCode and an operation type OpType. The OpType data being at least one bit less that a minimum binary size of an OpCode required to uniquely identify the microinstruction. The OpType data selected to indicate a category of microinstructions having common execution requirement characteristics. The microinstructions are selectively queued for pipeline processing by the execution unit pipelines based on the OpType without decoding the OpCode of the microinstruction.

### FIELD OF INVENTION

This application is related to processors and methods of processing.

### BACKGROUND

Conventionally processors are designed to process operations that are typically identified by operation codes (OpCodes). In the design of new processors, it is important to be able to process all of a standard set of operations so that existing computer programs based on the standardized codes will operate without the need for translating operations into an entirely new code base. Processor designs may further incorporate the ability to process new operations, but backwards compatibility to older instruction sets is often desirable.

Execution of microinstructions/operations is typically performed in an execution unit of a processor core. To increase speed, multi-core processors have been developed. Also to facilitate faster execution throughput, “pipeline” execution of operations within an execution unit of a processor core is used. Cores having multiple execution units for multi-thread processing are also being developed. However, there is a continuing demand for faster throughput for processors.

One type of standardized set of operations is the instruction set compatible with the prior art “x86” chips, e.g. 8086, 286, 386, etc. that have enjoyed widespread use in many personal computers. The microinstruction sets, such as the “x86” instruction set, include operations requiring numeric manipulation, operations requiring retrieval and/or storage of data, and operations that require both numeric manipulation and retrieval/storage of data. To execute such operations, execution units within processor cores have included two types of pipelines: arithmetic logic pipelines (“EX pipelines”) to execute numeric manipulations and address generation pipelines (“AG pipelines”) to facilitate load and store operations.

In order to quickly and efficiently process operations as required by a particular computer program, the program commands are decoded into operations within the supported set of microinstructions and dispatched to the execution unit for processing. Conventionally, an OpCode is dispatched that specifies what operation/microinstruction is to be performed along with associated information that may include items such as an address of data to be used for the operation and operand designations.

Dispatched instructions/operations are conventionally queued for a multi-pipeline scheduler of an execution unit. Queuing is conventionally performed with some type of decoding of a microinstruction's OpCode in order for the scheduler to appropriately direct the instructions for execution by the pipelines with which it is associated within the execution unit.

### SUMMARY OF EMBODIMENTS

Methods and apparatus for providing faster throughput of micro-instruction/operation execution with respect to a multi-pipeline processor execution unit.

In one aspect of the invention, an integrated circuit (IC) is provided that includes an execution unit having multiple pipelines where each pipeline is configured to execute a selected subset of a set of supported microinstructions. Preferably the microinstructions are identified by operation codes (OpCodes). The IC preferably includes a decoder unit configured to send packets of data with respect to a microinstruction to the execution unit. The microinstruction packets include data in an OpCode field that preferably has a size that is at least a minimum binary size required to uniquely identify the microinstruction within the set of supported microinstructions. The microinstruction packets also preferably include data in an operation type (OpType) field. The OpType field has a size smaller than the minimum binary size required to uniquely identify the microinstruction within the set of supported microinstructions. The OpType field data indicates a category of microinstructions having common execution requirement characteristics. The execution unit preferably includes a mapper configured to queue microinstructions into a scheduling queue for pipeline processing by the execution unit pipelines based on the OpType field data without decoding the OpCode field data of the microinstruction.

Methods for queuing microinstructions in a processor execution unit having multiple pipelines for executing selected subsets of a set of supported microinstructions that are identified by operation codes (OpCodes) are provided. In one method, data is received data by the execution unit with respect to a microinstruction including OpCode data of a first size that is at least a minimum binary size required to uniquely identify the microinstruction within the set of supported microinstructions and operation type (OpType) data having a size smaller than the minimum binary size that indicates a category of microinstructions having common execution requirement characteristics. The microinstruction is selectively queued for pipeline processing within the execution unit based on the OpType data without decoding the OpCode data of the microinstruction. Preferably, the supported set of microinstructions includes a standardized set of “x86” instructions and the execution unit receives data with respect to a microinstruction that includes OpCode data having at least an eight bit binary size and OpType data having a four bit binary size.

The data received by the execution unit with respect to a microinstruction may include load/store data having a two bit binary size that indicates whether the microinstruction includes a load operation, a store operation or a load/store operation. The selectively queuing the microinstruction for pipeline processing within the execution unit can be based on the OpType data and the load/store data. Preferably, the selectively queuing the microinstruction for pipeline processing within the execution unit is based on both the OpType data and the load/store data when two predetermined bits of the OpType data have a predetermined value.

In a preferred embodiment, the execution unit is configured to execute fixed point operations and a microinstruction is not queued for pipeline processing within the execution unit when the OpType data reflects that the microinstruction is a floating point operation without any fixed point component. Preferably, the execution unit is configured to receive data with respect to a plurality of microinstructions in parallel. In one example, the execution unit receives data for two microinstructions in parallel and a mapper within the execution unit selectively queues both microinstruction for pipeline processing in one clock cycle.

Other objects and advantages of the present invention will become apparent from the drawings and following detailed description of presently preferred embodiments.

### BRIEF DESCRIPTION OF THE DRAWINGS

FIG. 1 is a block diagram of pertinent portions of a processor core of configured in accordance with an embodiment of the present invention.

FIG. 2 is a graphic illustration of the format of a portion of an instruction information packet that is dispatched from a decoder unit to an execution unit within the processor core illustrated in FIG. 1.

FIG. 3 is a table reflecting operation type (OpType) categories and relative execution characteristics of the microinstructions that fall within each OpType for use in connection with support of an “x86” based instruction set.

FIG. 4 is a block diagram of a scheduler of the execution unit of the processor core of FIG. 1.

### DETAILED DESCRIPTION

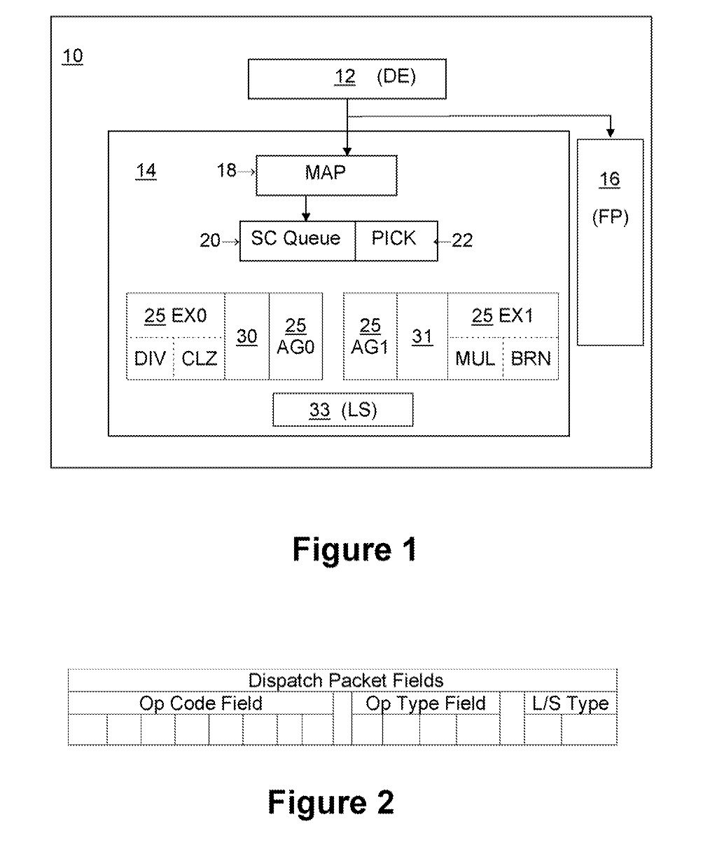

Referring to FIG. 1, an example of an embodiment of the invention is illustrated in the context of a processor core 10 of a multi-core Integrated Circuit (IC). The processor core 10 has a decoder unit 12 that decodes and dispatches microinstructions to a fixed point execution unit 14. Multiple fixed point execution units may be provided for multi-thread operation. In a preferred embodiment, a second fixed point execution unit (not shown) is provided for dual thread processing.

A floating point unit 16 is provided for execution of floating point instructions. Preferably, the decoder unit 12 dispatches instructions in information packets over a common bus to both the fixed point execution unit 14 and the floating point unit 16.

The execution unit 14 includes a mapper 18 associated with a scheduler queue 20 and a picker 22. These components control the selective distribution of operations among a plurality of arithmetic logic (EX) and address generation (AG) pipelines 25 for pipeline execution. The pipelines 25 execute operations queued in the scheduling queue 20 by the mapper 18 that are picked therefrom by the picker 22 and directed to an appropriate pipeline. In executing a microinstruction, the pipelines identify the specific kind of operation to be performed by a respective operation code (OpCode) assigned to that kind of microinstruction.

In a preferred example, the execution unit 14 includes four pipelines for executing queued operations. A first arithmetic logic pipeline EX0 and a first address generation pipeline AG0 are associated with a first set 30 of physical registers (PRNs) in which data is stored relating to execution of specific operations by those two pipelines. A second arithmetic logic pipeline EX1 and a second address generation pipeline AG1 are associated with a second set 31 of physical registers (PRNs) in which data is stored relating to execution of specific operations by those two pipelines. Preferably there are 96 PRNs in each of the first and second sets of registers 30, 31.

In the example execution unit shown in FIG. 1, the arithmetic pipelines EX0, EX1 have asymmetric configurations. The first arithmetic pipeline EX0 is preferably the only pipeline configured to process divide (DIV) operations and count leading zero (CLZ) operations within the execution unit 14. The second arithmetic pipeline EX1 is preferably the only pipeline configured to process multiplication (MUL) operations and branch (BRN) operations within the execution unit 14.

DIV and MUL operations generally require multiple clock cycles to execute. The complexity of both arithmetic pipelines is reduced by not requiring either of arithmetic pipelines to perform all possible arithmetic operations and dedicating multi-cycle arithmetic operations for execution by only one of the two arithmetic pipelines. This saves chip real estate while still permitting a substantial overlap in the sets of operations that can be executed by the respective arithmetic pipelines EX0, EX1.

The processing speed of the execution unit 14 can be affected by the operation of any of the components. Since all the microinstructions that are processed must be mapped by the mapper 18 into the scheduling queue 20, any delay in the mapping/queuing process can adversely affect the overall speed of the execution unit.

In conventional execution units, decoding of a microinstruction's OpCode is typically performed in order to queue operations for execution on an appropriate pipeline. This OpCode decoding correspondingly consumes processing time and power. Unlike conventional execution units, the mapper 18 does not perform OpCode decoding in connection with queuing operations into the scheduling queue 20.

To avoid the need for Op Code decoding by the mapper 18, the decoder 12 is configured to provide a relatively small additional field in the instruction information packets that it dispatches. This additional field reflects a defined partitioning of the set of microinstructions into categories that directly relate to execution pipeline assignments. Through this partitioning, the OpCodes are categorized into groups of operation types (OpTypes).

The partitioning is preferably such that there are at least half as many OpTypes as there are OpCodes. As a result, an OpType can be uniquely defined through the use of at least one less binary bit than is required to uniquely define the OpCodes.

Configuring the mapper 18 to conduct mapping/queuing based on OpType data instead of OpCode data enables the mapper 18 to be capable of performing at a higher speed since there is at least one less bit to decode in the mapping/queuing process. Accordingly, the decoder 12 is configured to dispatch instruction information packets that include a low overhead, i.e. relatively small, OpType field in addition to a larger OpCode field. The mapper 18 is then able to utilize the data in the OpType field, instead of the OpCode data, for queuing the dispatched operations. The OpCode data is passed via the scheduler to the pipelines for use in connection with executing the respective microinstruction, but the mapper does not need to do any decoding of the OpCode data for the mapping/queuing process.

In the example discussed below where support is provided for an “x86” based microinstruction set, the mapper 18 only needs to process a 4-bit OpType, instead of an 8-bit OpCode in the mapping/queuing process. This translates into an increase in the speed of the mapping/queuing process. The mapping/queuing process is part of a critical timing path of the execution unit 14 since all instructions to be executed must be queued. Thus an increase in the speed of the mapping/queuing process in turn permits the execution unit 14 as a whole to operate at an increased speed.

In a preferred embodiment, the processing core 10 is configured to support an instruction set compatible with the prior art “x86” chips, e.g. 8086, 286, 386, etc. This requires support for about 190 standardized “x86” instructions. As illustrated in FIG. 2, in such example, an OpCode field in the packets dispatched from the decoder 12 is configured with 8 bits in order to provide data that uniquely represents an instruction in an “x86” based instruction set. The 8-bit OpCode field does enable the unique identification of up to 256 microinstructions, so that an instruction set containing new instructions in addition to existing “x86” microinstructions is readily supported.

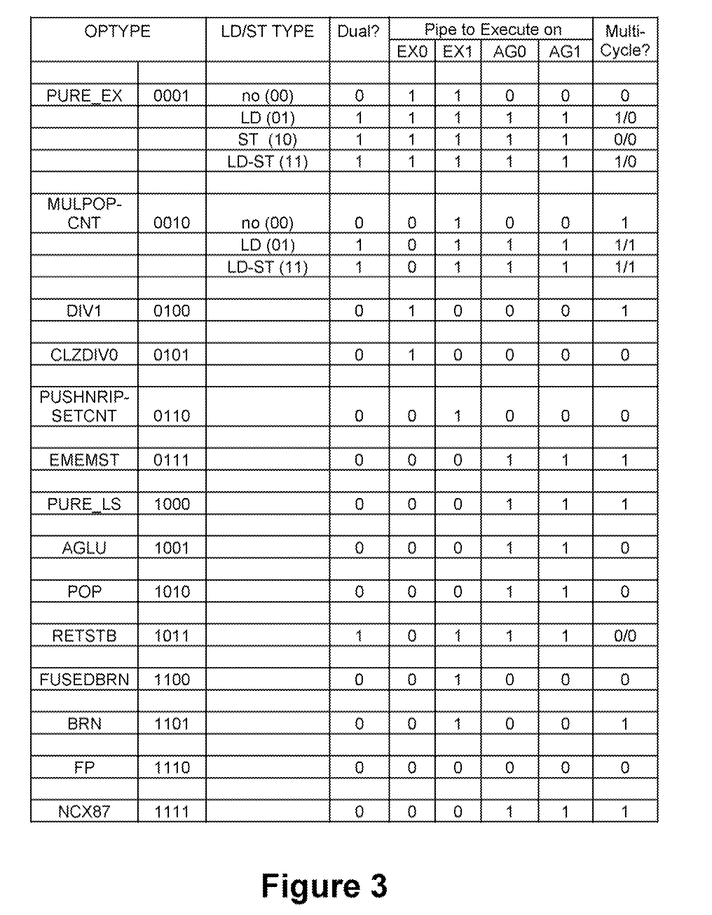

The “x86” based instruction set is preferably partitioned into 14 OpTypes as illustrated in FIG. 3. These OpTypes are uniquely identified by a four digit binary number as shown. As graphically illustrated in FIG. 2, a four bit OpCode field is provided in the instruction information packets dispatched from the decoder 12. Preferably, the decoder 12 is configured with a lookup table and/or hardwiring to identify an OpType from an OpCode for inclusion in each instruction information packet. Since the OpType is reflective of pipeline assignment information, it is not used in the decoding processing performed by the decoder 12. Accordingly, there is time to complete an OpType lookup based on the OpCode without delaying the decoding process and adversely affecting the operational speed of the decoder 12.

The use of an OpType field also provides flexibility for future expansion of the set of microinstructions that are supported without impairing the mapping/queuing process. Where more than 256 instructions are to be supported, the size of the OpCode field would necessarily increase beyond 8-bits. However, as long as the OpCodes can all be categorized into 16 or less OpTypes, a 4-bit OpType field can be used.

As reflected in FIG. 3, the microinstructions are categorized into OpTypes according to various characteristics related to their execution. Microinstructions for simple arithmetic operations within execution domains of both arithmetic pipelines EX0, EX1 are categorized with an OpType “PURE_EX” This is indicated in FIG. 3 with a “1” indication in both the EX0 and EX1 columns provided in that Figure.

An “x86” based micro-instruction set includes single component operations, namely, operations that have a single component requiring numeric manipulation and operations that have a single component requiring retrieval and/or storage of data. An “x86” based micro-instruction set also includes dual component operations, namely, operations that require both numeric manipulation and retrieval/storage of data. The arithmetic pipelines EX0, EX1 execute components of operations requiring numeric manipulation and the address generation pipelines AG0, AG1 execute components of operations requiring retrieval/storage of data. The dual component operations require execution with respect to both types of pipelines.

Depending upon the kind of operation, a microinstruction executed in one of the pipelines may require a single clock cycle to complete or multiple clock cycles to complete. For example, a simple add instruction can be performed by either arithmetic pipeline EX0 or EX1 in a single clock cycle. However, arithmetic pipeline EX0 requires multiple clock cycles to perform a division operation and arithmetic pipeline EX1 requires multiple clock cycles to perform a multiplication operation.

Preferably, any given type of multi-cycle arithmetic operation is dedicated to only one of the arithmetic pipelines EX0, EX1 and most single cycle arithmetic operations are within the execution domains of both arithmetic pipelines EX0, EX1. In the “x86” based instruction set, there are various multi-cycle arithmetic operations, namely multi-cycle Division (DIV) operations that fall within the execution domain of the arithmetic pipeline EX0 and multi-cycle Multiplication (MUL) operations and multi-cycle Branch (BRN) operations that fall within the execution domain of the arithmetic pipeline EX1. Accordingly, in the preferred example, the execution domains of the arithmetic pipelines EX0, EX1 substantially overlap with respect to single cycle arithmetic operations, but they are disjoint with respect to multi-cycle arithmetic operations.

There are three kinds of operations requiring retrieval and/or storage of data, namely, load (LD), store (ST) and load/store (LD-ST). These operations are performed by the address generation pipelines AG0, AG1 in connection with a Load-Store (LS) unit 33 of the execution unit 14 in the preferred example illustrated in FIG. 1.

Both LD and LD-ST operations generally are multi-cycle operations that typically require a minimum of 4 cycles to be completed by the address generation pipelines AG0, AG1. LD and LD-ST operations identify an address of data that is to be loaded into one of the PRNs of the PRN sets 30, 31 associated with the pipelines 25. Time is required for the LS unit 33 to retrieve the data at the identified address, before that data can loaded in one of the PRNs. For LD-ST operations, the data that is retrieved from an identified address is processed and subsequently stored in the address from where it was retrieved.

ST operations typically require a single cycles to be completed by the address generation pipelines AG0, AG1. This is because a ST operation will identify where data from one of the PRNs of the PRN sets 30, 31 is to be stored. Once that address is communicated to the LS unit 33, it performs the actual storage so that the activity of the address generation pipeline AG0, AG1 is complete after a single clock cycle.

In a preferred embodiment, as graphically illustrated in FIG. 2, a two bit load/store type (LD/ST Type) is provided in the instruction information packets dispatched from the decoder 12 to indicate whether the instruct has a LD, ST or LD-ST component or no component requiring retrieval/storage of data. A preferred 2-bit identification of these characteristics is reflected in the LD/ST Type column in FIG. 3 where 00 indicates the instruction has no component requiring retrieval/storage of data.

In the preferred embodiment, the mapper 18 is configured to use a combination of the OpType field data and the LD/ST Type field data in connection with queuing the microinstructions corresponding to the dispatched packets to reflect a determination of not only the eligible pipelines for execution of the microinstruction, but also whether the microinstruction has a multi-cycle component or is a dual component microinstruction. FIG. 3 reflects preferred OpType categories and the above noted execution characteristics of the microinstructions that fall within each OpType.

In the provided example, the PURE_EX OpType is used with respect to single cycle arithmetic operations within the execution domains of both arithmetic pipelines EX0, EX1. The PURE_EX OpType operations may or may not include a retrieval/storage of data component. For example, one kind of addition instruction, such as ADD, does not have a retrieval/storage of data component and another kind of addition instruction, such as LD-ADD, does have a retrieval/storage of data component, namely a load component. As such, the ADD instruction is a PURE_EX OpType instruction that is not a dual component operation as indicated by a “0” in FIG. 3 in the “Dual?” column. The LD-ADD instruction is a PURE_EX OpType operation that has dual components as indicated by a “1” in FIG. 3 in the “Dual?” column.

An OpType designation MULPOPCNT corresponding to OpType field data 0010 is used with respect to all microinstructions having a MUL arithmetic component. To indicate that the MUL component operations can only be executed on pipeline EX1, a “0” is contained in the EX0 column and a “1” is contained in the EX1 column with respect to the MULPOPCNT entries in FIG. 3.

The PURE_EX and MULPOPCNT OpTypes are the only OpTypes that do not by themselves indicate whether a corresponding microinstruction has dual components. All of the other OpTypes directly reflect whether the microinstructions within their corresponding OpType categories have dual components. For example, all of the microinstructions within the DIV1 OpType category do not have dual components, and all of the microinstructions within the RETSTB OpType category do have dual components as reflected in the “Dual?” column of FIG. 3.

The PURE_EX and MULPOPCNT OpTypes are also the only OpTypes that have two leading “0s” in their four-bit representations. Accordingly, the mapper is preferably configured to only reference the LD/ST Type field data in connection with using the OpType field data when the leading two digits of the OpType field are both “0.” When this does occur, reference to the LD/ST Type filed data is made to determine whether the microinstruction has dual components, and if so, whether the address generation component is single or multi-cycle.

For example, for an ADD instruction referenced above, the mapper 18 receives a dispatched packet having OpType field data (0001) and LD/ST Type field data (00). The mapper 12 is preferably configured to first check the first two digits of the OpType field data (0001). Upon determining that those two digits are both “0” it then checks the LD/ST Type field data. Since that data is “00” in this case, the mapper 18 proceeds to queue the ADD instruction as a single component, single cycle operation eligible for execution on either arithmetic pipeline EX0 or EX1.

A simple move (MOV) instruction is also a single component, single cycle operation that falls within the PURE_EX OpType, but has a different OpCode designation. As with the dispatch of an ADD instruction, a MOV instruction will be dispatched in a packet having OpType field data (0001) and LD/ST Type field data (00). The mapper 12 will first check the first two digits of the OpType field data (0001). Upon determining that those two digits are both “0” it then checks the LD/ST Type field data. Since that data is “00” in this case as well, the mapper 18 proceeds to queue the MOV instruction in the same manner it had queued the ADD instruction referenced above. Reference is not required to the 8-bit OpCode data for performing the queuing function in either case.

As noted above, an LD-ADD instruction falls within the PURE_EX OpType and has dual components. For a LD-ADD instruction, the corresponding dispatched packet will have OpType field data (0001) and LD/ST Type field data (01). The mapper 12 first checks the first two digits of the OpType field data (0001). Upon determining that those two digits are both “0,” it then checks the LD/ST Type field data. Since that data is “01” in this case, the mapper 18 proceeds to queue the LD-ADD instruction as a dual component instruction having a single cycle arithmetic operation eligible for execution on either arithmetic pipeline EX0 or EX1 and a multi-cycle address generation component eligible for execution on either address generation pipeline AG0 or AG1.

In FIG. 3, a “1” is used in the “Multi-cycle?” column to indicate a multi-cycle operation component. For microinstructions within OpType categories that have dual components, the first digit in the “Multi-cycle?” column indicates whether the address generation component is a multi-cycle operation component and the second digit in the “Multi-cycle?” column indicates whether the arithmetic component is a multi-cycle operation component.

For an instruction that falls within the MULPOPCNT OpType, the corresponding dispatched packet will have OpType field data (0010) and LD/ST Type field data having data reflective of whether the instruction has a LD or LD-ST component. There are presently no multiplication type instructions that include a ST component, so such contingency is not provided for in the FIG. 3 table for the MULPOPCNT OpType entries.

For a MULPOPCNT OpType instruction, the mapper 12 first checks the first two digits of the OpType field data (0001). Upon determining that those two digits are both “0,” it then checks the LD/ST Type field data. The mapper 18 is configured to then proceed to queue the instruction as having a multi-cycle arithmetic operation eligible for execution on only the arithmetic pipeline EX1. It also determines whether the instruction has a multi-cycle address generation component eligible for execution on either address generation pipeline AG0 or AG1 based on the LD/ST Type field data and queues the instruction accordingly.

For an instruction that does not fall within the PURE_EX and MULPOPCNT OpType, when the mapper 12 first checks the first two digits of the OpType field data, it will discover that those two digits are not both “0.” It then does not have to check the LD/ST Type field data, but can proceed to queue the instruction in accordance with that instruction's OpType characteristics that are reflected in FIG. 3 for each of the OpTypes. There is one exception, namely, if the instruction falls within the floating point (FP) OpType in which case it is not queued in the scheduler of the execution unit 14.

The FP OpType is provided for microinstructions that require floating point execution and do not have any fixed point execution component. For an instruction that falls within the FP OpType, the mapper 12 will not proceed to queue the instruction in the scheduler queue 20. The floating point unit 16 also receives the instruction information packets and can also use the OpType field data to determine whether or not an instruction has a floating point component for execution in the floating point unit 16.

As will be readily recognized by those skilled in the art, the decode logic to perform the mapping and queuing functions based on the OpType field is substantially decreased since a 4-bit OpType is decoded to provide the required information instead of decoding the 8-bit OpCode field data to obtain essentially the same information. Although there is extra decoding of the LD/ST Type field data in connection with the PURE_EX and MULPOPCNT OpType, this only requires a minor amount of additional logic, since the LD/ST Type field data need only be used where the mapper's check of the first two digits of the OpType field data determines that those two digits are both “0.” The logic is preferably configured to instruct the mapper to consider the two bits of LD/ST Type field data in parallel with considering the last two digits of the OpType field data when the first two digits of the OpType field data are determined to both be “0.”

As reflected in FIG. 3, instructions within the EMEMST, PURE_LS and NCX87 OpTypes all have the same relative execution characteristic with respect to their being multi-cycle operations that are executable on either address generation pipeline AG0, AG1. The EMEMST category is provided for microinstructions that have these two characteristics and that also have a floating point component. As such, the floating point unit 16 will also recognize instruction information packets that have OpType field data (0111) as having a floating point component for execution in the floating point unit 16. Like the EMEMST category, the NCX87 category is used for microinstructions having these two characteristics and that also have a floating point component. However, the NCX87 category instructions are primarily based upon “x87” chip instructions.

As reflected in FIG. 3, instructions within the AGLU and POP OpTypes all have the same relative execution characteristic with respect to their being single-cycle operations that are executable on either address generation pipeline AG0, AG1. The ALGU category is provided for microinstructions that have these two characteristics, but the AGLU category is provided for microinstructions that do not have a memory component. A POP category instruction (POP/PUSH/RET) writes a result at the time when its address is generated and writes another result when the load component returns from the cache subsystem. An AGLU category instruction executes in the same hardware, but it does not generate a memory address and it only writes its first result as a destination.

The use of the OpCodes enables the mapper 18 to more quickly perform the mapping of microinstruction information and the queuing of the instructions for pipeline processing irrespective of the type of scheduling queue that is provided. Accordingly, enhanced performance can be realized whether each pipeline has its own scheduler queue, multiple sets of pipelines each have a respective queue or whether a single unified queue is provided for queuing instructions for all pipelines.

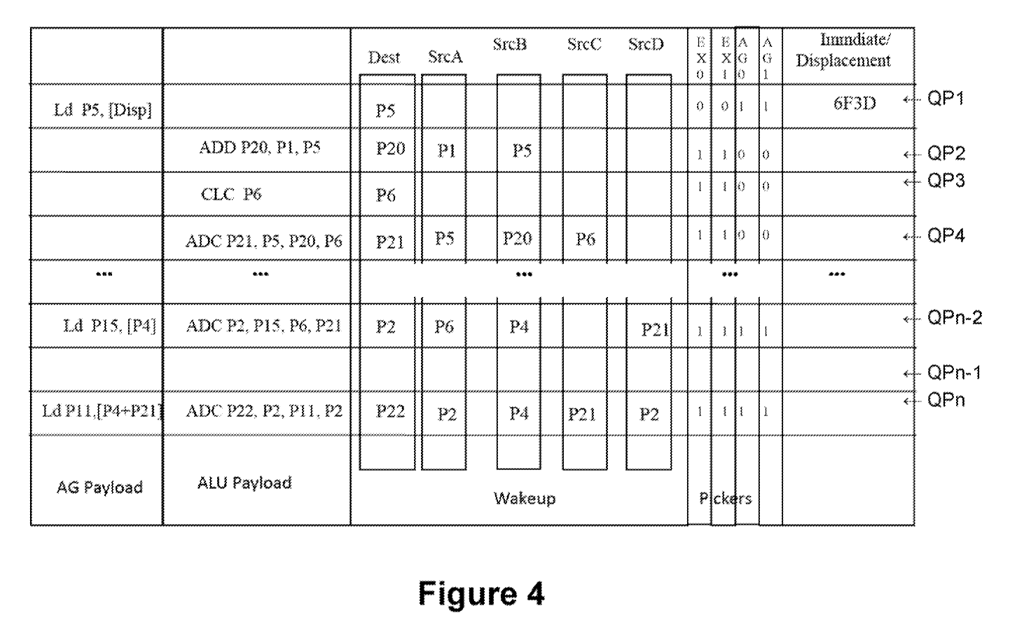

In a preferred embodiment, the scheduler queue 20 is configured as a unified queue for queuing instructions for all execution pipelines 25 within the execution unit 14. A block diagram of the unified scheduler queue is provided in FIG. 4.

Referring to FIG. 4, the block diagram of the scheduler queue 20 illustrates a plurality of queue positions QP1 . . . QPn. The scheduler preferably has 40 positions. Generally it is preferable to have at least five times as many queue positions as there are pipelines to prevent bottlenecking of the unified scheduler queue. However when a unified queue that services multiple pipelines has too many queue positions, scanning operations can become time prohibitive and impair the speed in which the scheduler operates. In the preferred embodiment, the scheduler is sized such that queued instructions for each of the four pipelines can be picked and directed to the respective pipeline for execution in a single cycle. The full affect of the scheduler's speed directing the execution of queued instructions can be realized because there is no impediment in having instructions queued into the scheduler queue due to the mapper's speed in queuing instructions based on OpTypes as described above.

In the preferred example illustrated in FIG. 1, the mapper 18 is configured to queue a microinstruction into an open queue position based on the microinstruction's information packet received from the decoder 12. Preferably the mapper 18 of execution unit 14 is configured to receive two instruction information packets in parallel which the mapper preferably queues in a single clock cycle. In a preferred embodiment configured with a second similar fixed point execution unit (not shown), the decoder is preferably configured to dispatch four instruction information packets in parallel. Two of the packets are preferably flagged for potential execution by the execution unit 14 and the other two flagged for potential execution by the second similar fixed point execution unit.

Preferably, the floating point unit 16 scans the OpType of all four packets dispatched in a given clock cycle. Any floating point instruction components indicated by the scan of the OpType fields data of the four packets are then queued and executed in the floating point unit 16.

The mapper is preferably configured to make a top to bottom scan and a bottom to top scan in parallel of the queue positions QP1-QPn to identify a topmost open queue position and bottom most open queue position; one for each of the two microinstructions corresponding to two packets received in a given clock cycle.

Where the OpType field data of a dispatched packet indicates OpType FP, the microinstruction corresponding to that packet is not queued because it only requires execution by the floating point unit 16 as discussed above. Accordingly, even when two instruction information packets are received from the decoder 12 in one clock cycle, one or both microinstructions may not be queued in the scheduler queue 20 for this reason.

Each queue position QP1 . . . QPn is associated with memory fields for an Address Generation instruction (AG Payload), an Arithmetic/Logic instruction (ALU Payload), four Wake Up Content Addressable Memories (CAMs) ScrA, ScrB, ScrC, ScrD that identify addresses of PRNs that contain source data for the instruction and a destination Random Access Memory (RAM) (Dest) that identifies a PRN where the data resulting from the execution of the microinstruction is to be stored.

A separate data field (Immediate/Displacement) is provided for accompanying data that an instruction is to use. Such data is sent by the decoder in the dispatched packet for that instruction. For example, a load operation LD is indicated in queue position QP1 that seeks to have the data stored at the address 6F3D indicated in the Immediate/Displacement data field into the PRN identified as P5. In this case, the address 6F3D was data contained in the instruction's information packet dispatched from the decoder 12. That information was transferred to the Immediate/Displacement data field for queue position QP1 in connection with queuing that instruction to queue position QP1.

The AG Payload and ALU payload fields are configured to contain the specific identity of an instruction as indicated by the instruction's OpCode along with relative address indications of the instruction's required sources and destinations that are derived from the corresponding dispatched data packet. In connection with queuing, the mapper translates relative source and destination addresses received in the instruction's information packet into addresses of PRNs associated with the pipelines 25.

The mapper tracks relative source and destination address data received in the instruction information packets so that it can assign the same PRN address to a respective source or destination where two instructions reference the same relative address. For example, P5 is indicated as one of the source operands in the ADD instruction queued in queue position QP2 and P5 is also identified as the destination address of the result of the LD operation queued in queue position QP1. This indicates that the dispatched packet for the LD instruction indicated the same relative address for the destination of the LD operation as the dispatched packet for the ADD instruction had indicated for one of the ADD source operands.

In the scheduler queue 20, flags are provided to indicate eligibility for picking the instruction for execution in the respective pipelines as indicated in the columns respectively labeled EX0, EX1, AG0, and AG1. The execution unit picker 22 preferably includes an individual picker for each of the four pipelines EX0, EX1, AG0, AG1. Each respective pipeline's picker scans the respective pipeline picker flags of the queue positions to find queued operations that are eligible for picking. Upon finding an eligible queued operation, the picker checks to see if the instruction is ready to be picked. If it is not ready, the picker resumes its scan for an eligible instruction that is ready to be picked. Preferably, the EX0 and AG0 pickers scan the flags from the top queue position QP1 to the bottom queue position QPn and the EX1 and AG1 pickers scan the flags from the bottom queue position QPn to the top queue position QP1 during each cycle. A picker will stop its scan when it finds an eligible instruction that is ready and then direct that instruction to its respective pipeline for execution. Preferably this occurs in a single clock cycle.

Readiness for picking is indicated by the source wake up CAMs for the particular operation component being awake indicating a ready state. Where there is no wake up CAM being utilized for a particular instruction component, the instruction is automatically ready for picking. For example, the LD operation queued in queue position QP1 does not utilize any source CAMs so that it is automatically ready for picking by either of the AG0 or AG1 pickers upon queuing. In contrast, the ADD instruction queued in queue position QP2 uses the queue position's wake up CAMs ScrA and ScrB. Accordingly, that ADD instruction is not ready to be picked until the PRNs P1 and P5 have been indicated as ready by queue position QP2's wake up CAMs ScrA and ScrB being awake.

Where one of the arithmetic pipelines is performing a multi-cycle operation, the pipeline preferably provides its associated picker with an instruction to suspend picking operations until the arithmetic pipeline completes execution of that multi-cycle operation. In contrast, the address generation pipelines are preferably configured to commence execution of a new address generation instruction without awaiting the retrieval of load data for a prior instruction. Accordingly, the pickers will generally attempt to pick an address generation instruction for each of the address generation pipelines AG0, AG1 for each clock cycle when there are available address generation instructions that are indicated as ready to pick.

In some cases, the CAMs may awake before the required data is actually stored in the designated PRN. Typically, when a load instruction is executed where a particular PRN is indicated as the load destination, that PRN address is broadcast after four cycles to the wake up CAMs to wake up all the CAMs designated with the PRN's address. Four cycles is a preferred nominal time it takes to complete a load operation. However, it can take much longer if the data is to be retrieved by the LS unit 33 from a remote location. Where an instruction is picked before the PRN actually contains the required data, the execution unit is preferably configured to replay the affected instructions which are retained in their queue positions until successful completion.

The queue position's picker flags are set in accordance with the pipeline indications in FIG. 3 with respect to the microinstruction's OpType and, where needed, LD/ST Type. Where the microinstruction's OpType and LD/ST Type indicate that it is not a dual component instruction, the mapper's process for proceeding with queuing the instruction is fairly straight forward.

In the single component instruction case, the pipeline designations indicate that the instruction is either an arithmetic operation or an address generation operation through the eligible pipe indication. Where an arithmetic operation is indicated, the ALU payload field of the queue position is filled with the OpCode data to indicate the specific kind of operation and appropriately mapped PRN address information indicating sources and a destination. Where an address generation operation is indicated, the AG payload field of the queue position is filled with the OpCode data to indicate the specific kind of operation and appropriately mapped PRN address information indicating sources and a destination. In both cases, the wake up CAMs can be supplied with the sources indicated in the payload data and the destination RAM can be supplied with the destination address indicated in the payload data.

In the dual component instruction case, the mapper 18 must account for the fact that the instruction has both an arithmetic operation component and an address generation operation component. In general for dual component instructions, the dispatched packets will contain information related to sources and a destination of the entire microinstruction. In queuing a dual component microinstruction, the mapper proceeds to map the relative source and destination addresses to PRN addresses for the wake up CAMs and the destination RAM. However, there will not be a direct correspondence of a single payload field to the CAMs, because each of the ALU and AG payload fields of the queue position requires data reflective of the respective component of the dual component microinstruction.

In this situation, the mapper is tasked with providing appropriate payload data in both the ALU and AG payload fields of the queue position. Both fields are preferably supplied with the OpCode to identify the specific kind of instruction to the pipeline that will execute the respective instruction component. However, only one of the payload fields will reflect the destination address corresponding to the relative destination address supplied by the dual component microinstruction's information packet which is used for the destination RAM of the queue position.

For a dual component instruction, the mapper takes into account that the result of one component must be used in the other component. Accordingly, the mapper 18 assigns an address of a PRN as a linking address within the ALU and AG payload fields of the queue position. The mapper preferably uses the LD/ST Type field data to determine whether the dual component microinstruction's relative destination is related to the arithmetic operation component or the address generation operation component of the microinstruction.

If the mapper determines that the dual component microinstruction's relative destination is related to the arithmetic operation component, the destination within the ALU payload field will be assigned the address that corresponds to the microinstruction's relative destination address. In this situation, the result of the address generation operation component is used in the arithmetic operation component. Accordingly, the mapper 18 assigns the linking PRN address as the destination within the AG payload field and the linking PRN address as a source within the ALU payload field of the queue position.

If the mapper determines that the dual component microinstruction's relative destination is related to the address generation operation component, the destination within the AG payload field will be assigned the address that corresponds to the microinstruction's relative destination address. In this situation, the result of the arithmetic operation component is used in the address generation operation component. Accordingly, the mapper 18 assigns the linking PRN address as the destination within the ALU payload field and the linking PRN address as a source within the AG payload field of the queue position.

An example of the queuing of a dual component microinstruction is provided with respect to queue position QPn-2 into which a dual load-add with carry (LD-ADC) instruction has been mapped. In this case the LD-ADC's relative destination is related to the ADC arithmetic component of the instruction. The destination within the ALU payload field has been assigned the PRN address P2 that corresponds to the microinstruction's relative destination address in the received information packet. P2 is also reflected as the destination RAM address. The mapper 18 has assigned P15 for the linking PRN address and it appears as the destination of the LD component within the AG payload field and as a source of the ADC component within the ALU payload field of the queue position QPn-2.

The other PRN source addresses for the LD and ADC components reflected in the ALU and AG payload fields correspond to relative source addresses from the microinstruction's information packet. These other PRN source addresses are also the addresses used by the wake up CAMs queue position QPn-2. In this case the source of the LD component tied to wake up CAM ScrB and is indicated by PRN address P4. The other two sources for the ADC component are tied to wake up CAMs ScrA and ScrD and are indicated by PRN addresses P6 and P21 respectively.

In determining whether either component of the LD-ADC dual component instruction is ready to be picked, ADC-LD, the respective pickers evaluate the readiness of the respective sources. The LD component will be ready for picking when the wake up CAM ScrB is awakened to indicate that the desired data has been stored to PRN P4. Since this is the only source of the LD component, the awaking of CAM ScrB is the only requirement for readiness with respect to the LD component. When the LD component is then picked by either the AG0 or AG1 picker, the AG payload is directed to the respective AG pipeline to execute the LD component of the dual component microinstruction queued in queue position QPn-2.

The ADC component will be ready for picking when both wake up CAMs ScrA and ScrD are awaken to indicate that the desired data has been stored to PRNs P6 and P21. These are not the only sources of the ADC component, so that the ADC component will not be ready for picking until there is also an indication that the LD component had already been picked. Since an LD operation nominally takes four cycles to complete, an indication of readiness of the linking source of the ADC component is preferably delayed four cycles after the LD operation was picked. When all three sources of the ADC component of the microinstruction queued in queue position QPn-2 are indicated as ready, the ADC component can then be picked by either the EX0 or EX1 picker. When this occurs, the ALU payload is directed to the respective EX pipeline to execute the ADC component of the queued dual component micro instruction.

A second example of the queuing of a dual component microinstruction is provided with respect to queue position QPn into which a slightly different kind of dual load-add with carry (LD-ADC) instruction has been mapped. In this case the LD-AD C's relative destination is related to the ADC component of the instruction. The destination within the ALU payload field has been assigned the PRN address P22 that corresponds to the microinstruction's relative destination address in the received information packet. P22 is also reflected as the destination RAM address. The mapper 18 has assigned P11 for the linking PRN address and it appears as the destination of the LD component within the AG payload field and as a source of the ADC component within the ALU payload field of the queue position QPn.

The other PRN source addresses for the LD and ADC components reflected in the ALU and AG payload fields correspond to relative source addresses from the microinstruction's information packet. These other PRN source addresses are also the addresses used by the wake up CAMs queue position QPn. In this case the source of the LD component is the sum of the data of two sources that have been assigned PRN addresses P4 and P21 and the LD requires both wake up CAMs ScrB and ScrC to be awake in order for the instruction to be picked for the execution of the LD component of the microinstruction.

This type of scheduling of dual component microinstructions in a unified scheduling queue enables highly efficient execution of the queued operations that is realized in increased overall throughput processing speed of the execution unit 14. It provide a vehicle to make highly efficient usage of the pipeline processing resources by efficient queuing and picking of both arithmetic and address generation components of both single and dual component microinstructions.

Although features and elements are described above in particular combinations, each feature or element can be used alone without the other features and elements or in various combinations with or without other features and elements. The apparatus described herein may be manufactured by using a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Embodiments of the present invention may be represented as instructions and data stored in a computer-readable storage medium. For example, aspects of the present invention may be implemented using Verilog, which is a hardware description language (HDL). When processed, Verilog data instructions may generate other intermediary data, (e.g., netlists, GDS data, or the like), that may be used to perform a manufacturing process implemented in a semiconductor fabrication facility. The manufacturing process may be adapted to manufacture semiconductor devices (e.g., processors) that embody various aspects of the present invention.

Suitable processors include, by way of example, a general purpose processor, a special purpose processor, a conventional processor, a digital signal processor (DSP), a plurality of microprocessors, a graphics processing unit (GPU), a DSP core, a controller, a microcontroller, application specific integrated circuits (ASICs), field programmable gate arrays (FPGAs), any other type of integrated circuit (IC), and/or a state machine, or combinations thereof.

What is claimed is:

1. A method for queuing microinstructions in a processor execution unit having multiple pipelines for executing selected subsets of a set of supported microinstructions that are identified by operation codes (OpCodes), the method comprising:
receiving data by the execution unit with respect to a microinstruction including OpCode data identifying the microinstruction within the set of supported microinstructions and operation type (OpType) data indicating a category of microinstructions having common execution requirement characteristics; and
selectively queuing the microinstruction for pipeline processing within the execution unit based on the OpType data without decoding the OpCode data of the microinstruction.

2. The method of claim 1 where the supported set of microinstructions includes a standardized set of “x86” instructions wherein the receiving data by the execution unit with respect to a microinstruction includes receiving OpCode data having at least an eight bit binary size and OpType data having a four bit binary size.

3. The method of claim 2 wherein the receiving data by the execution unit with respect to a microinstruction includes receiving load/store data that indicates whether the microinstruction includes a load operation, a store operation or a load/store operation and the selectively queuing the microinstruction for pipeline processing within the execution unit is selectively based on the OpType data and the load/store data.

4. The method of claim 3 wherein the selectively queuing the microinstruction for pipeline processing within the execution unit is based on both the OpType data and the load/store data when two predetermined bits of the OpType data have a predetermined value.

5. The method of claim 1 where the execution unit is configured to execute fixed point operations.

6. The method of claim 5 wherein the microinstruction is not queued for pipeline processing within the execution unit when the OpType data reflects that the microinstruction is a floating point operation without any fixed point component.

7. A method for queuing microinstructions in a processor execution unit having multiple pipelines for executing selected subsets of a set of supported microinstructions that are identified by operation codes (OpCodes), the method comprising:
receiving data by the execution unit with respect to a plurality of microinstructions in parallel including, for each microinstruction, receiving OpCode data identifying the microinstruction within the set of supported microinstructions and operation type (OpType) data indicating a category of microinstructions having common execution requirement characteristics; and
selectively queuing each microinstruction for pipeline processing within the execution unit based on its respective OpType data without decoding its respective OpCode data.

8. The method of claim 7 where the supported set of microinstructions includes a standardized set of “x86” instructions and the execution unit is configured to execute fixed point operations.

9. The method of claim 8 wherein the receiving data by the execution unit with respect to a plurality of microinstructions includes receiving for each microinstruction load/store data indicating whether the microinstruction includes a load operation, a store operation or a load/store operation and the selectively queuing each microinstruction for pipeline processing within the execution unit is selectively based on its respective OpType data and its respective load/store data.

10. The method of claim 9 wherein the selectively queuing each microinstruction for pipeline processing within the execution unit is based on both its respective OpType data and its respective load/store data when two predetermined bits of its respective OpType data have a predetermined value.

11. The method of claim 8 wherein a microinstruction is not queued for pipeline processing within the execution unit when its OpType data reflects that the microinstruction is a floating point operation without any fixed point component.

12. The method of claim 8 the receiving data by the execution unit with respect to a plurality of microinstructions includes receiving data for two microinstructions in parallel and the selectively queuing each microinstruction for pipeline processing within the execution unit is performed for the two microinstructions in one clock cycle.

13. An integrated circuit (IC) comprising:
an execution unit having multiple pipelines, each pipeline configured to execute selected subsets of a set of supported microinstructions that are identified by operation codes (OpCodes);
the execution unit configured to receive data with respect to microinstructions including, for each microinstruction, OpCode data identifying the microinstruction within the set of supported microinstructions and operation type (OpType) data indicating a category of microinstructions having common execution requirement characteristics; and
the execution unit including a mapper configure to selectively queue each microinstruction for pipeline processing by the execution unit pipelines based on its OpType data without decoding its OpCode data.

14. The IC of claim 13 where the supported set of microinstructions includes a standardized set of “x86” instructions.

15. The IC of claim 14 wherein the execution unit is configured to receive data with respect to each microinstruction that includes load/store data indicating whether the microinstruction includes a load operation, a store operation or a load/store operation.

16. The IC of claim 15 wherein the mapper is configured to selectively queue each microinstruction for pipeline processing within the execution unit based on both its OpType data and its load/store data when two predetermined bits of its OpType data have a predetermined value.

17. The IC of claim 13 wherein the execution unit is configured to execute fixed point operations and the mapper is configured to not queue a microinstruction for pipeline processing within the execution unit when its OpType data reflects that the microinstruction is a floating point operation without any fixed point component.

18. The IC of claim 14 wherein the execution unit is configured to receive data with respect to a plurality of microinstructions in parallel.

19. The IC of claim 18 wherein the execution unit is configured to execute fixed point operations and the mapper is configured to not queue a microinstruction for pipeline processing within the execution unit when its OpType data reflects that the microinstruction is a floating point operation without any fixed point component.

20. The IC of claim 18 the execution unit is configured to receive data for two microinstructions in parallel and the mapper is configured to selectively queue the two microinstructions for pipeline processing within the execution unit in one clock cycle.

21. A computer-readable storage medium storing a set of instructions for execution by one or more processors to facilitate manufacture of an execution unit of an integrated circuit that includes multiple pipelines for executing selected subsets of a set of supported microinstructions that are identified by operation codes (OpCodes) and that is adapted:
receive data with respect to a microinstruction including OpCode data identifying the microinstruction within the set of supported microinstructions and operation type (OpType) data indicating a category of microinstructions having common execution requirement characteristics; and
selectively queue the microinstruction for pipeline processing within the execution unit based on the OpType data without decoding the OpCode data of the microinstruction.

22. The computer-readable storage medium of claim 21, wherein the instructions are hardware description language (HDL) instructions used for the manufacture of a device.

23. A method for queuing microinstructions dispatched from a decoder to an execution unit configured to execute fixed point operations and a floating point unit where the execution unit has multiple pipelines for executing selected subsets of microinstructions of a set of supported microinstructions that are identified by operation codes (OpCodes), the method comprising:
dispatching data to the execution and floating point units with respect to a microinstruction including OpCode data identifying the microinstruction within the set of supported microinstructions and operation type (OpType) data indicating a category of microinstructions having common execution requirement characteristics; and
selectively queuing the microinstruction for pipeline processing within the execution unit based on the OpType data without decoding the OpCode data of the microinstruction when the OpType data reflects that the microinstruction is not a floating point operation without any fixed point component.

24. The method of claim 23 wherein any floating point component of the microinstruction is processed within the floating point unit when the OpType data reflects that the microinstruction has a floating point component.
